(19) United States
(12) Patent Application Publication
(10) Pub. No.: US 2026/0192803 A1
(43) Pub. Date: Jul. 9, 2026

(54) BRAKING SYSTEM FOR A MOTOR VEHICLE THAT CAN BE DRIVEN BY AN ELECTRIC MACHINE

(71) Applicant: Schaeffler Technologies AG & Co. KG, Herzogenaurach (DE)

(72) Inventors: Simon Ortmann, Pulheim (DE); Benedikt Grubauer, Neresheim (DE)

(73) Assignee: Schaeffler Technologies AG & Co. KG, Herzogenaurach (DE)

(21) Appl. No.: 19/133,227

(22) PCT Filed: Nov. 6, 2023
(86) PCT No.: PCT/DE2023/100824

§ 371 Date: May 28, 2025

(30) Foreign Application Priority Data
Nov. 28, 2022 (DE) 10 2022 131 330.1

(51) Int. Cl. B60W 30/18; B60W 10/08; B60W 10/184

(52) U.S. Cl. CPC B60W 30/18127; B60W 10/08; B60W 10/184; B60W 2520/10; B60W 2540/215; B60W 2710/083; B60W 2710/18

(57) ABSTRACT

A braking system for a motor vehicle includes a brake device, an electric machine, a service brake system and a system controller. The electric machine has a rotor arranged to be torque-transmitting coupled to the brake device and to a vehicle wheel. The service brake system is arranged for selectively braking the vehicle wheel. The system controller has a memory with a plurality of stored operating modes, and a processor arranged for commanding a braking torque from the brake device, the electric machine operating in a generator mode, or the service brake system depending on a driving operating state of the motor vehicle.

### CROSS-REFERENCE TO RELATED APPLICATIONS

This application is the United States National Phase of PCT Appln. No. PCT/DE 2023/100824 filed Nov. 6, 2023, which claims priority to German Application No. DE 102022131330.1 filed Nov. 28, 2022, the entire disclosures of which are incorporated by reference herein.

### TECHNICAL FIELD

The present disclosure relates to a braking system for a motor vehicle that can be driven by an electric machine. The electric machine has a rotor, which can be torque-transmittingly coupled to a brake device and to at least one vehicle wheel. The braking system also has a service brake system for wheel-selective braking torque application to at least the vehicle wheels on a first vehicle axle.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to. A detailed description of an electric drive can be found, for example, in an article in the magazine ATZ, volume 113, 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle which comprises an electric motor arranged coaxially with respect to a bevel gear differential.

Motor vehicles of this type with a hybridized or electrified drive train can not only accelerate, but also brake with the aid of an electric machine. During the braking process, the electric machine is operated as a generator and the recuperated energy is used to charge the battery, for example. For safety reasons, however, an additional mechanical brake device is still required. For drives close to the wheel, such as a wheel hub motor or an electric axle, this results in a more difficult installation space situation.

In particular, a vehicle including an electric wheel hub drive, a so-called e-wheel drive, often uses brakes with plates to brake the vehicle. However, disc brakes with floating calipers, disc brakes with fixed calipers, drum brakes and multi-disc brakes are also known.

DE 10 2019 120 409 A1, for example, discloses a brake device for a wheel hub drive assembly in which the braking partners, which are fixed relative to the circumferential direction, have cooling channels. The axially movable braking partner is actuated via brake cylinders. The braking partner, which is movable in the circumferential direction, is designed as a plate carrier.

It is also known to include generator-driven electric machines in the braking strategy of an electrically operated motor vehicle. US 2019/0225199 A1, for example, describes what a brake blending strategy might look like for a vehicle that has conventional wheel brakes and a recuperation brake using an electric motor.

### SUMMARY

The present disclosure provides a braking system for a motor vehicle that can be driven by an electric machine. The electric machine has a rotor, which can be torque-transmittingly coupled to a brake device and to at least one vehicle wheel, and the braking system also has a service brake system for wheel-selective braking torque application to at least the vehicle wheels on a first vehicle axle. The braking system includes a system controller in which a plurality of operating modes of the braking system are stored, which carry out a different distribution of braking torques between the brake device, the electric machine in generator mode and the service brake system according to a current driving operating state of the motor vehicle.

With this braking system, optimum deceleration of the motor vehicle can be achieved depending on the driving mode, in particular using the brake device coupled to the electric machine. This allows a driving state-specific braking strategy to be realized which, depending on the operating or driving state, integrates the various braking options provided by the braking system, depending on the currently activated operating mode or modes. The operating modes can vary, for example between “emission-free braking”, “noiseless braking”, “maximum recuperation (energy input into the vehicle)”, “maximum heat energy recovery” and “minimum braking distance and stabilization of the vehicle (safety functions ESP and ABS)”.

The service brake system includes at least one service brake (friction brake), for example a disc brake. The kinetic energy of the vehicle is converted into heat by friction and released into the surrounding air. At the same time, fine dust emissions are produced by abrasion of the brake disc and brake pads.

In generator mode, the electric machine can act as a recuperation brake, in which energy is recovered by the electric machine. The vehicle's kinetic energy is fed into the battery. No emissions are produced.

The braking system includes an electric machine. The brake device is intended for a motor vehicle that can be electrically driven by means of an electric machine. Electric machines within the meaning of this application are used to convert electrical energy into mechanical energy and/or vice versa, and usually have a stationary part referred to as a stator, column or stationary anchor, and a part referred to as a rotor or runner and arranged to be movable relative to the stationary part. In connection with the present disclosure, an electric machine can be designed in particular as a rotary machine. With such electric rotary machines, a distinction is made in particular between radial flow machines and axial flow machines. In a radial flow machine, the magnetic field lines extend in the radial direction in the air gap formed between the rotor and stator, while in the case of an axial flow machine, the magnetic field lines extend in the axial direction in the air gap formed between the rotor and stator.

In the context of the present disclosure, an electric machine is provided in particular for use within a drive train of a hybrid or fully electrically powered motor vehicle. In particular, the electric machine is dimensioned such that vehicle speeds of more than 50 km/h, more than 80 km/h, or more than 100 km/h can be achieved. The electric machine may have an output of more than 30 kW, more than 50 kW, or more than 70 kW. Furthermore, the electric machine may provide speeds greater than 5000 rpm, greater than 10,000 rpm, or greater than 12,500 rpm.

The electric machine can have a housing, also known as a motor housing. The motor housing encloses the electric machine. A motor housing can also accommodate the control and power electronics unit, and may also accommodate at least parts of the braking system. The motor housing can also be part of a cooling system for the electric machine, and can be designed such that cooling fluid can be supplied to the electric machine via the motor housing and/or the heat can be dissipated to the outside via the motor housing surfaces. In addition, the motor housing protects the electric machine and any electronics from external mechanical and/or chemical influences.

A motor housing of the electric machine can be formed of a metallic material in particular. The motor housing can be formed from a metallic cast material, such as gray cast iron or cast steel. In principle, it is also conceivable to form the motor housing entirely or partially from a plastic. It is also possible for the motor housing of the electric machine to be designed in one piece or in several parts.

A rotor is the rotating (spinning) part of an electric machine. The rotor has a rotor shaft and one or more rotor bodies formed of rotor lamination stacks which are arranged on the rotor shaft in a rotationally fixed manner. The rotor shaft can be hollow, which, on the one hand, results in a weight reduction and, on the other hand, allows the supply of lubricant or coolant to the rotor body. In particular, the rotor shaft can be coupled to the brake shaft of the brake device.

The electric machine can be coupled to a transmission, which is designed to generate a drive torque for the motor vehicle. The drive torque may be a main drive torque, such that the motor vehicle is driven exclusively by the drive torque.

In particular, it may be provided that the electric machine and the transmission are arranged in a shared drive train housing. Alternatively, it would of course also be possible for the electric machine to have a motor housing and the transmission to have a transmission housing, and the structural unit can then be brought about by fixing the transmission assembly in relation to the electric machine. This structural unit is sometimes also referred to as an e-axle. The drive train housing may be formed from a metallic material, e.g., from aluminum, gray cast iron or cast steel, in particular by means of a primary shaping process such as casting or die-casting. In principle, however, it would also be possible to form the drive train housing from a plastic material. The drive train housing can particularly have a cup-like basic shape, such that the electric machine and the transmission can be inserted into the drive train housing via the open end face thereof.

The electric machine may have a motor housing and/or the transmission may have a transmission housing, and the structural unit can then be implemented by fixing the transmission in relation to the electric machine. The transmission housing is a housing for accommodating a transmission. It has the task of guiding existing shafts via the bearings and giving the wheels (cam discs, where applicable) the degrees of freedom they require under all loads without impeding their rotational and possible path movement, as well as absorbing bearing forces and supporting torques. A transmission housing can be designed as single-shell or multi-shell, i.e., undivided or divided. In particular, the transmission housing should be able to dampen noise and vibrations as well as safely absorb hydraulic fluid. The transmission housing may be formed from a metallic material, e.g., from aluminum, gray cast iron or cast steel, in particular by means of a primary shaping process such as casting or die-casting.

Furthermore, the transmission can be configured as a planetary transmission or comprise a planetary transmission. The planetary transmission can have a sun gear and a plurality of planetary gears which mesh with the sun gear, are rotatably mounted in a planetary gear carrier and which rotate around the sun gear, as well as a ring gear which is arranged coaxially with respect to the sun gear and in which the planetary gears roll.

The transmission can also have a differential gear. A differential gear is a planetary transmission with one drive and two outputs. It usually has the function of driving two vehicle wheels of a motor vehicle in such a way that they can turn at different speeds when cornering, but with the same propulsive force.

In order to implement different drive or operating modes for the motor vehicle, one or more separating clutches can be provided within the torque path between the electric machine and a vehicle wheel. A separating clutch can be arranged, for example, between the output of the electric machine and the input of the transmission so that the electric machine can be decoupled from the transmission, allowing the motor vehicle to be operated in a coasting mode. It would also be conceivable to arrange a separating clutch between the output of the transmission and a vehicle wheel or the vehicle wheels, also allowing the motor vehicle to be operated in coasting mode. Finally, it is also possible to arrange a separating clutch between the input of the brake device and the output of the electric machine, which allows the brake device to be completely decoupled from the electric machine.

For the purposes of this disclosure, motor vehicles are land vehicles which are moved by machine power without being bound to railroad tracks. A motor vehicle can be selected, for example, from the group of passenger cars, trucks, small motorcycles, light motor vehicles, motorcycles, motor buses/coaches, or tractors.

A system controller has, in particular, a wired or wireless signal input for receiving, in particular, electrical signals, such as sensor signals, for example. Furthermore, a control unit may also have a wired or wireless signal output for transmitting signals, in particular electrical signals, for example to actuators of the brake device, to actuators of the service brake system and/or to the electric machine.

Open-loop control operations and/or closed-loop control operations can be carried out within the system controller. The system controller may have hardware that is designed to run software. The system controller may have at least one electronic processor for executing program sequences defined in software.

The system controller can also have one or more electronic memories in which the data contained in the signals transmitted to the control unit can be stored and read out again. Furthermore, the system controller can have one or more electronic memories in which data can be stored in a modifiable and/or non-modifiable manner.

A system controller can have a plurality of control units which are arranged in particular spatially separate from one another. Control units are also referred to as electronic control units (ECU) or electronic control modules (ECM) and may have electronic microcontrollers for carrying out computing operations for processing data, e.g., using software. The control units can be interconnected with one another such that a wired and/or wireless data exchange between control units is made possible. In particular, it is also possible to interconnect the control units with one another via bus systems, such as a CAN bus or LIN bus, for example.

In particular, a brake actuator has the function of actuating the brake device, i.e., setting it to a friction-fit operating state and an operating state released from the frictionally locking connection. In particular, the brake actuator can be actuated pneumatically, hydraulically, by an electric motor, mechanically, electromagnetically or any combination of these. The brake actuator may be configured as an electromechanical brake actuator.

The present disclosure can also be designed in such a way that the service brake system is designed for wheel-selective braking torque application to the vehicle wheels of the first vehicle axle and the vehicle wheels of a second vehicle axle, which further improves the braking performance of the brake system.

According to an example embodiment, it can be provided that at least one operating mode, into which the braking system can be set, can be selected by a user of the braking system, so that the braking behavior can be selected by a user. According to a further development, it can also be provided that at least one operating mode, into which the braking system can be set, can be selected by the system controller, so that an automatic selection of one or more operating modes is carried out by the system controller.

Furthermore, according to an example embodiment, it may be provided that, in a first operating mode of the braking system, the distribution of the braking torques is configured such that, in a first speed interval of the motor vehicle, a vehicle braking torque is provided exclusively by the brake device and/or the electric machine in generator mode. This design enables particularly quiet and emission-free deceleration of the motor vehicle.

According to a further embodiment, it may be provided that, in a second operating mode of the braking system, the distribution of the braking torques is configured such that, in a second speed interval of the motor vehicle, the vehicle braking torque is provided by the brake device, the service brake system and the electric machine in generator mode. This avoids or reduces the use of the service brake system's friction brakes and only using them in extreme cases of high vehicle speeds.

In this context, the first speed interval of the first operating mode and the second speed interval of the second operating mode may not overlap, so that both operating modes can also be executed simultaneously in principle.

Furthermore, the present disclosure can also be further developed such that, in a third operating mode of the braking system, the distribution of the braking torques is configured such that, in a third speed interval of the motor vehicle, the vehicle braking torque has a braking torque generated by the brake device. This means that, for example, the frictional torque support provided by the brake device can be used to heat the transmission and control the temperature of the battery when the motor vehicle is in cold mode.

In an example embodiment, it can also be provided that, in a fourth operating mode of the braking system, the distribution of the braking torques is configured such that the vehicle braking torque is generated exclusively by the service brake system, for example in the event of emergency braking, ABS braking or ESP intervention.

The brake device may have a friction brake, in particular selected from the group of disc brakes, drum brakes, multi-disc brakes, wherein the friction brake is accommodated in a brake housing.

The brake device may be arranged in a brake housing. The brake housing encloses the brake device. A brake housing can also accommodate one or more brake actuators. The brake housing can also be part of a cooling system, and can be designed in such a way that cooling fluid can be supplied to the brake system via the brake housing and/or the heat can be dissipated to the outside via the housing surfaces. The brake housing also protects the brake device from external mechanical and/or chemical influences. In particular, a brake housing can be formed from a metallic material. The brake housing can be formed from a metallic cast material, such as gray cast iron or cast steel. In principle, it is also conceivable to make the brake housing entirely or partially out of plastic. Furthermore, it is possible for the brake housing to be designed in one piece or in several parts.

The brake housing can also be designed completely or partially as part of a motor housing of an electric machine or a transmission housing of a transmission coupled to the electric machine. The brake housing and the motor housing or the transmission housing may form a single structural unit. For example, the brake housing can be screwed to the motor housing or the transmission housing. The brake housing may be designed in such a way that abrasion particles generated during braking cannot escape from the brake housing. This prevents unwanted pollution of the environment with brake dust. Braking noise can also be reduced by encapsulating the braking system in this way. With this encapsulation, the braking performance of the braking system is independent of the weather conditions outside the motor vehicle.

According to a further embodiment, it may be provided that the brake device has a brake cooling circuit, by means of which heat can be dissipated from the brake device and supplied to a thermal management system of the motor vehicle.

In the context of the present disclosure, the term thermal management refers to the demand-oriented and efficient control of thermal energy flows in an electrically drivable motor vehicle, in particular a battery-powered motor vehicle, according to the prevailing operating or load condition.

The thermal management system of the motor vehicle can include a hydraulic control system. A hydraulic control system directs the volumetric flow rates within a thermal management system of a motor vehicle by means of switching elements that act hydraulically on a fluid, such as valves, slides, pumps and the like. The hydraulic control system can, for example, completely or partially throttle a volume flow and/or distribute it to the relevant heat sources and sinks in sub-circuits of the thermal management system of a motor vehicle. For this purpose, the hydraulic switching elements are controlled and switched by the electronic control unit.

A hydraulic switching element can be a hydraulic pump, a switching valve, a controllable throttle valve and the like. A hydraulic switching element can be electrically controlled. Furthermore, a hydraulic switching element may have at least two different, switchable operating states in which the hydraulic switching element acts in different ways on the corresponding fluid in a circuit.

According to an example embodiment, it is therefore possible for the brake to have a brake cooling circuit for dissipating or supplying heat from or to the brake, and the hydraulic control unit acts on the brake cooling circuit by means of at least one hydraulic switching element to influence the volumetric flow rates in the brake cooling circuit.

According to an example embodiment, it is possible for the electric machine to have a motor cooling circuit for dissipating or supplying heat from or to the electric machine, and the hydraulic control unit acts on the motor cooling circuit by means of at least one hydraulic switching element to influence the volume flows in the motor cooling circuit.

According to an example embodiment, it can be provided that the thermal management system also has an inverter with an inverter cooling circuit for removing heat from or supplying heat to the inverter, and the hydraulic control unit acts on the inverter cooling circuit by means of at least one hydraulic switching element in order to influence the volume flows in the inverter cooling circuit.

According to an example embodiment, it can be provided that the vehicle battery has a battery cooling circuit for dissipating or supplying heat from or to the vehicle battery, and the hydraulic control unit acts on the battery cooling circuit by means of at least one hydraulic switching element to influence the volume flows in the battery cooling circuit.

An operating mode may be selected by the system controller taking into account one or more operating parameters of the motor vehicle, selected from a group including an outside temperature, a battery temperature, a required braking energy, a yaw angle, a vehicle wheel speed, a rotor speed and/or a transmission temperature.

In principle, the first operating mode and/or the second operating mode and/or the third operating mode may be executed simultaneously, so that the advantages of the different operating modes can be combined.

### BRIEF DESCRIPTION OF THE DRAWINGS

The present disclosure is explained in more detail below with reference to figures without limiting the general concept of the disclosure.

In the figures:

FIG. 1 shows an axle drive train with a braking system in a schematic axial sectional view,

FIG. 2 shows a braking system of a motor vehicle in a schematic block diagram,

FIG. 3 shows a first operating mode of the braking system in a diagram showing the distribution of the braking torques according to the vehicle speed,

FIG. 4 shows a second operating mode of the braking system in a diagram showing the distribution of the braking torques according to the vehicle speed,

FIG. 5 shows a third operating mode of the braking system in a diagram showing the distribution of the braking torques according to the vehicle speed, and

FIG. 6 shows a fourth operating mode of the braking system in a diagram showing the distribution of the braking torques according to the vehicle speed.

### DETAILED DESCRIPTION

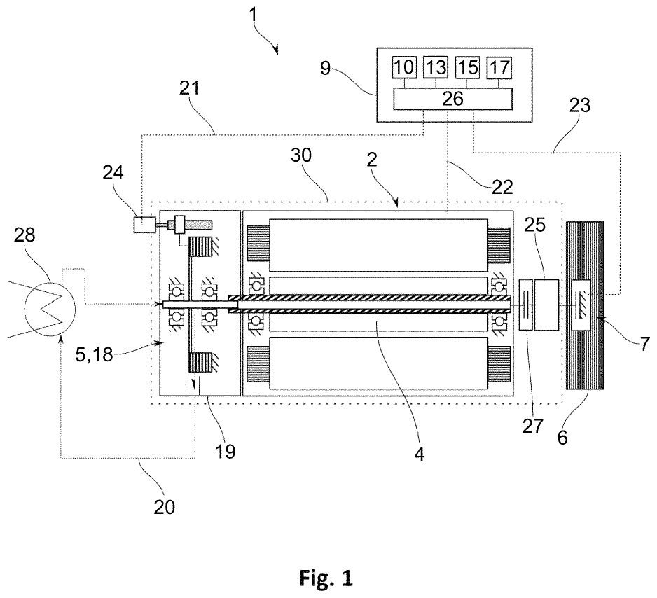

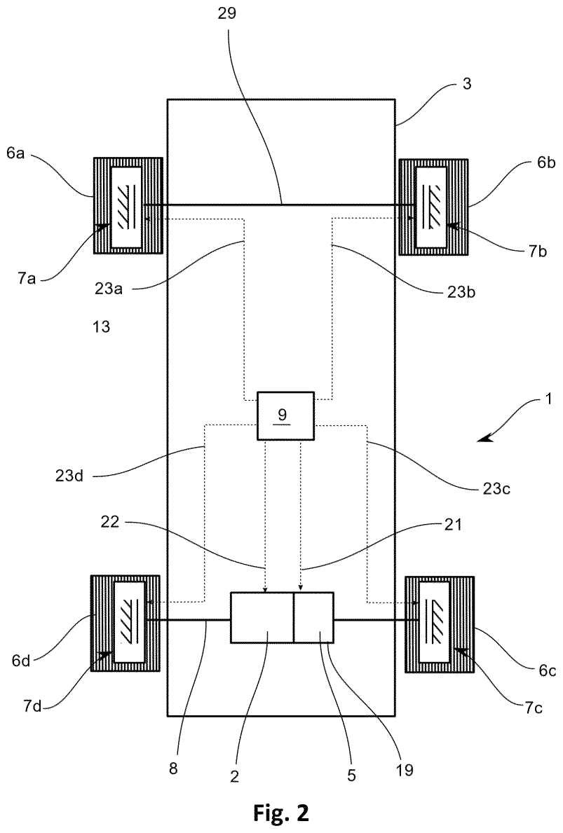

FIG. 1 shows a braking system 1 of a motor vehicle 3 that can be driven electrically by means of an electric machine 2, as is also shown by way of example in FIG. 2.

The electric machine 2 has a rotor 4, which can be torque-transmittingly coupled to a brake device 5 and to at least one vehicle wheel 6. The braking system 1 also has a service brake system 7 for the wheel-selective braking torque application to at least the vehicle wheels 6 of the first vehicle axle 8 and a second vehicle axle 29, which can also be clearly seen in FIG. 2. The brake device 5 is formed as a friction brake 18, in particular selected from the group of disc brakes, drum brakes, multi-disc brakes, and the friction brake 18 is accommodated in a brake housing 19. It can also be seen from FIG. 1 that the brake device 5 has a brake cooling circuit 20, by means of which heat can be dissipated from the brake device 5 and supplied to a thermal management system of the motor vehicle 3 via the heat exchanger 28.

The electric machine 2, the brake device 5 and the transmission 25 form a structural unit, which is also referred to as the axle drive train 30. In order to enable the motor vehicle to coast, for example, the separating clutch 27 is arranged between the vehicle wheel 6 and the electric machine 2.

The brake device 5 is coupled to a brake cooling circuit 20, by means of which heat can be dissipated from the brake device 5. The brake device 5 can be actuated by means of a brake actuator 24, which is an electric motor connected to a spindle drive in the example shown. FIG. 1 clearly shows that closing the brake device 5 immediately applies a deceleration torque to the rotor 4 of the electric machine 2 and also to the vehicle wheel 6. The brake device 5 is accommodated in a brake housing 19, which forms a structural unit with the electric machine 2.

In this configuration, three different deceleration torques can therefore act on one or more of the vehicle wheels 6: the deceleration torque generated by the brake device 5, the deceleration torque generated by the electric machine 2 and/or the deceleration torque generated by the service brake system 7. Depending on the driving situation and deceleration requirements, these three available deceleration torques can be combined and applied in a controlled manner.

To control these braking or deceleration torques, the braking system 1 has a system controller 9 which, when an input brake signal is present, in particular depending on the current driving state of the motor vehicle 3, transmits a first control signal 21, which represents a deceleration torque to the brake device 5 and/or transmits a second control signal 22 which represents a deceleration torque to the electric machine 2 and/or transmits a third control signal 23 which represents a deceleration torque to the service brake system 7.

The second control signal 22, which represents a deceleration torque, sets the electric machine 2 to generator mode. This architecture can be seen particularly well in FIG. 2.

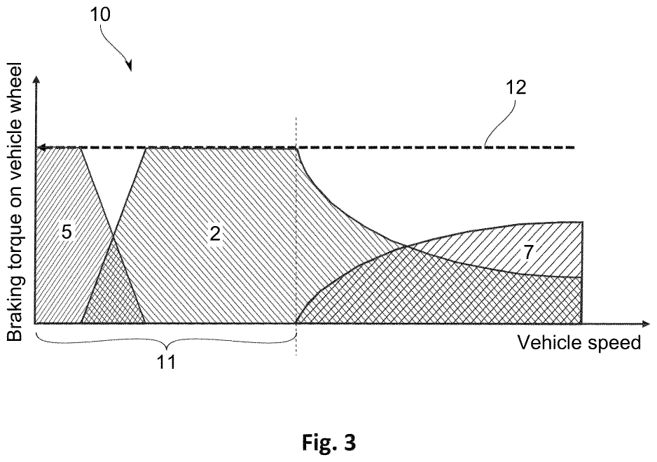

The braking system 1 includes a system controller 9 in which a plurality of operating modes 10, 13, 15, 17 of the braking system 1 are stored, which carry out a different distribution of braking torques between the brake device 5, the electric machine 2 in generator mode and the service brake system 7 according to a current driving operating state of the motor vehicle 3. These operating modes 10, 13, 15, 17, which are implemented as software code, are then loaded into a processor 26 within the system controller 9 and processed there. These operating modes 10, 13, 15, 17 will be explained in more detail below with reference to FIGS. 3-6.

The selection of an operating mode 10, 13, 15, 17 or several operating modes 10, 13, 15, 17, into which the braking system 1 can be set, can be carried out manually by a user of the braking system 1, for example by means of corresponding selection switches. Alternatively or additionally, it is of course also possible that an operating mode 10, 13, 15, 17 17 or several operating modes 10, 13, 15, 17, into which the braking system 1 can be set, can be selected by the system controller 9.

As shown in FIG. 3, in a first operating mode 10 of the braking system 1, the distribution of the braking torques is configured such that, in a first speed interval 11 of the motor vehicle 3, a vehicle braking torque 12 is provided exclusively by the brake device 5 and/or the electric machine 2 in generator mode. The objective for the system controller 9 in this first operating mode 10 is therefore to operate the braking system 1 with maximum recuperation and maximum freedom from emissions. As can be seen from the diagram in FIG. 3, the friction brakes of the service brake system must be added at high speeds; at low speeds, when the recuperation capacity of the electric machine 2 decreases, the brake device 5 takes over. At low speeds within the first speed interval 11, the motor vehicle 3 is thus decelerated solely by the brake device 5 and is also held at a standstill.

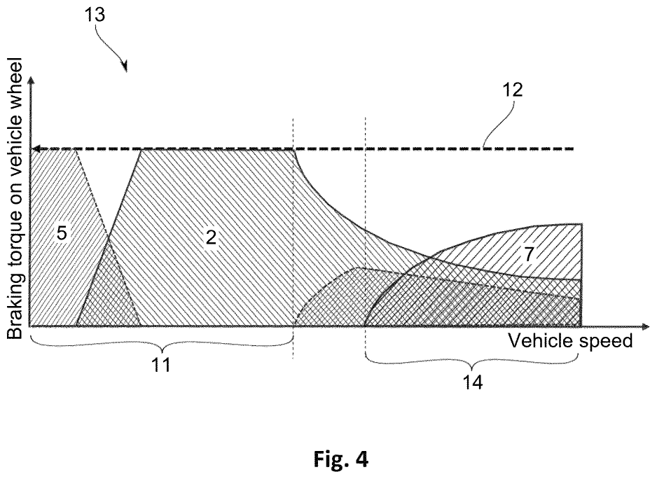

FIG. 4 also shows that, in a second operating mode 13 of the braking system 1, the distribution of the braking torques is configured such that, in a second speed interval 14 of the motor vehicle 3, the vehicle braking torque 12 is provided by the brake device 5, the service brake system 7 and the electric machine 2 in generator mode.

This operating mode 13 therefore has a blending and additional support of the braking effect by the brake device 5 in the range of higher speeds. The aim here is to avoid using the friction brakes of the service brake system 7 as much as possible. This results in a further reduction in the demand on the friction brakes of the service brake system. The capability curve of the brake device 5 is shown in the diagram in FIG. 4 sloping downwards towards higher speeds. This is because the required braking performance increases sharply with increasing speed. This is based on the assumption that these higher braking powers cannot be completely dissipated by the brake device.

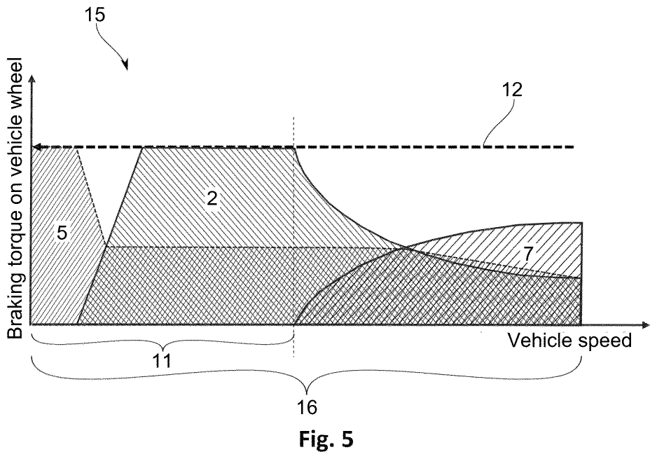

FIG. 5 also shows that, in a third operating mode 15 of the braking system 1, the distribution of the braking torques is configured such that, in a third speed interval 16 of the motor vehicle 3, the vehicle braking torque 12 has a braking torque generated by the brake device 5. FIG. 5 therefore clearly shows how the brake device 5 can be used in cold temperatures, for example. The aim here is to raise the temperature of key components such as the transmission and battery quickly to increase efficiency. For this purpose, the recuperation power of the electric machine 2 is reduced and the lost torque is replaced by the brake device 5. This generates frictional heat in the brake device 5, which can then be used to increase efficiency. As soon as all components are within the ideal temperature window, the system switches back to the first operating mode, for example.

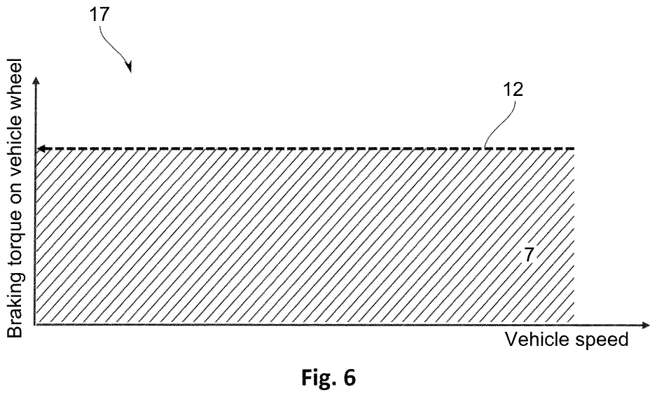

FIG. 6 shows that, in a fourth operating mode 17 of the braking system 1, the distribution of the braking torques is configured such that the vehicle braking torque 12 is generated exclusively by the service brake system 7. FIG. 6 thus shows a braking strategy for full brake application, emergency braking or ESP application. The recuperation function of the electric machine 2 and brake device 5 is reduced to zero in order to enable the most precise wheel-selective braking possible. This state serves as a fallback level, as vehicles in P4 configuration without torque vectoring cannot be operated with a central brake device in critical driving situations. By using a differential, torque can only be controlled on an axle-by-axle basis, but not wheel-selectively as required.

FIGS. 1-6 therefore show how, by selecting an ideal braking strategy (operating modes), the blending of three braking systems (electric machine 2, brake device 5, service brake system 7) results in advantages for the vehicle as a whole in terms of zero emissions, recuperation capability and increased efficiency.

The disclosure is not limited to the embodiments shown in the figures. The above description is therefore not to be regarded as limiting, but rather as illustrative. A stated feature may be present in at least one embodiment. This does not exclude the presence of further features. Where the claims and the above description define “first” and “second” features, this designation serves to distinguish between two features of the same type without defining an order of precedence.

### REFERENCE NUMERALS

1 Braking system
2 Electric machine
3 Motor vehicle
4 Rotor
5 Brake device
6 Vehicle wheel
7 Service brake system
8 Vehicle axle
9 System controller
10 Operating mode
11 Speed interval
12 Vehicle braking torque
13 Operating mode
14 Speed interval
15 Operating mode
16 Speed interval
17 Operating mode
18 Friction brake
19 Brake housing
20 Brake cooling circuit
21 Control signal
22 Control signal
23 Control signal
24 Brake actuator
25 Transmission
26 Processor
27 Separating clutch
28 Heat exchanger
29 Vehicle axle
30 Axle drive train

1. A braking system for a motor vehicle which can be driven by an electric machine, wherein the electric machine has a rotor, which can be torque-transmittingly coupled to a brake device and to at least one vehicle wheel, wherein the braking system also has a service brake system for wheel-selective braking torque application to at least the vehicle wheels on a first vehicle axle,
wherein:
the braking system comprises a system controller in which a plurality of operating modes of the braking system are stored, which carry out a different distribution of braking torques between the brake device, the electric machine in generator mode and the service brake system according to a current driving operating state of the motor vehicle.

2. The braking system according to claim 1,
wherein:
at least one operating mode into which the braking system can be set, can be selected by a user of the braking system.

3. The braking system according to claim 1,
wherein:
at least one operating mode into which the braking system can be set, can be selected by the system controller.

4. The braking system according to claim 1,
wherein:
in a first operating mode of the braking system, the distribution of the braking torques is configured such that, in a first speed interval of the motor vehicle, a vehicle braking torque is provided exclusively by the brake device or the electric machine in generator mode.

5. The braking system according to claim 1,
wherein:
in a second operating mode of the braking system, the distribution of the braking torques is configured such that, in a second speed interval of the motor vehicle, a vehicle braking torque is provided by the brake device, the service brake system and the electric machine in generator mode.

6. The braking system according to claim 1,
wherein:
in a third operating mode of the braking system, the distribution of the braking torques is configured such that, in a third speed interval of the motor vehicle, a vehicle braking torque always comprises a braking torque generated by the brake device.

7. The braking system according to claim 1,
wherein:
in a fourth operating mode of the braking system, the distribution of the braking torques is configured such that a vehicle braking torque is generated exclusively by the service brake system.

8. The braking system according to claim 1,
wherein:
the brake device comprises a friction brake selected from the group consisting of disc brakes, drum brakes, and multi-disc brakes, wherein the friction brake is accommodated in a brake housing.

9. The braking system according to claim 1,
wherein:
the brake device comprises a brake cooling circuit, by means of which heat can be dissipated from the brake device and supplied to a thermal management system of the motor vehicle.

10. The braking system according to claim 1,
wherein:
an operating mode is selected by the system controller taking into account one or more operating parameters of the motor vehicle, selected from the group consisting of an outside temperature, a battery temperature, a required braking energy, a yaw angle, a vehicle wheel speed, a rotor speed, and/or a transmission temperature.

11. The braking system according to claim 1,
wherein:
at least two of the stored operating modes are executed simultaneously.

12. A braking system for a motor vehicle, comprising:
a brake device;
an electric machine comprising a rotor arranged to be torque-transmittingly coupled to the brake device and to a vehicle wheel;
a service brake system arranged for selectively braking the vehicle wheel; and
a system controller comprising:
a memory comprising a plurality of stored operating modes; and
a processor arranged for commanding a braking torque from the brake device, the electric machine operating in a generator mode, or the service brake system depending on a driving operating state of the motor vehicle.

13. The braking system of claim 12, wherein a one of the stored operating modes can be selected by a user of the braking system.

14. The braking system of claim 12, wherein a one of the stored operating modes can be selected by the system controller.

15. The braking system of claim 12, wherein a one of the stored operating modes is arranged to distribute the braking torque such that a vehicle braking torque is provided exclusively by the brake device or the electric machine operating in the generator mode when the motor vehicle is operating within a first speed interval.

16. The braking system of claim 12, wherein a one of the stored operating modes is arranged to distribute the braking torque such that a vehicle braking torque is provided by the brake device, the service brake system, and the electric machine operating in the generator mode when the motor vehicle is operating within a second speed interval.

17. The braking system of claim 12, wherein a one of the stored operating modes is arranged to distribute the braking torque such that a vehicle braking torque is at least partially provided by the brake device when the motor vehicle is operating within a third speed interval.

18. The braking system of claim 12, wherein a one of the stored operating modes is arranged to distribute the braking torque such that a vehicle braking torque is provided exclusively by the service brake system.

19. The braking system of claim 14, wherein the system controller selects a one of the stored operating modes based on an operating parameter selected from the group consisting of an outside temperature, a battery temperature, a required braking energy, a yaw angle, a vehicle wheel speed, a rotor speed, or a transmission temperature.
